(19) United States
(12) Patent Application Publication
(10) Pub. No.: US 2017/0364558 A1
(43) Pub. Date: Dec. 21, 2017

(54) SYSTEM AND METHODS FOR PROCESSING LARGE SCALE DATA

(71) Applicant: Columbus Technology LLC, New Albany, OH (US)

(72) Inventors: Victor Thorne, New Albany, OH (US); Mac Liaw, Westerville, OH (US); Nathan Zender, Grove City, OH (US)

(21) Appl. No.: 15/629,055

(22) Filed: Jun. 21, 2017

Related U.S. Application Data
(60) Provisional application No. 62/352,584, filed on Jun. 21, 2016.

(51) Int. Cl. G06F 17/30

(52) U.S. Cl. CPC G06F 17/30463; G06F 17/30486; G06F 17/30371; G06F 17/30457

(57) ABSTRACT

A clustered system is provided for querying large amounts of data at fast speed allowing for variable sampling and speculation to speed up subsequent queries. An API using actor messages is provided to the user to be able to send SQL queries, the desired sample rater and the cube schema in which the user believes all queries in this session should fit. The underlying data store is agnostic and can utilize any system that supports aggregation.

### CROSS-REFERENCE TO RELATED APPLICATIONS

This application claims the benefit of U.S. Provisional Patent Application No. 62/352,584, filed Jun. 21, 2016, and makes a claim of priority thereto. The entire contents of U.S. Provisional Patent Application No. 62/352,584 are hereby incorporated by reference as if fully recited herein.

### TECHNICAL FIELD

Exemplary system and method embodiments are directed to the injection, management, and querying of large scale data in clustered systems.

### BACKGROUND

Companies in various industries manage massive amounts of data. For example, companies in the health insurance industry store large amounts of data pertaining to insureds' personal identifying and health information, insurance coverage, claims, prescriptions, pharmacy information, doctor information, etc. This data is often collected and stored over the span of decades. This does not just occur in the health insurance industry. In every industry sector massive amounts of data is piling up. As the amount of data increases and data analysis demands also increase and evolve, companies not only need a way to ensure proper storage and retrieval, but a way to analyze large amounts of data in little time. For a company managing significant volumes of data, a database query of relatively low complexity may not return a result for hours or even days. The time it takes to perform queries is often unreasonable and detrimental to system users, who typically need answers in real-time.

Accuracy of data querying is also a concern, since as the data set increases in size and complexity, there is more room for error.

Historically, data injection methods have been centralized solutions based on a lowest common denominator. Although this has made for a simple process for the user, it is a very slow process.

Exemplary system and method embodiments described herein solve these and other problems, and additionally offer a novel approach to the manner in which databases can be queried.

### SUMMARY OF THE INVENTION

Exemplary system and method embodiments described and depicted herein are directed generally to increasing the speed at which large amounts of data can be queried, as well as increasing the accuracy of query results. To this end, exemplary system and method embodiments include improved systems and methods for distributed and interactive cube exploration.

In one embodiment, systems and methods for importing data into the distributed system are provided through the use of an API that allows for individual inserts, bulk load, and customizable table creation. Data management and manipulation, including data replication, data partitioning, data repair, and data deletion, allow for a system with increased query efficiency and accuracy. Data injection takes advantage of every node in the cluster, and also leverages each underlying storage engine's unique features. Every node contributes to the process and the user is able to select the storage engine to use, further enhancing the process.

Customization allows for the user to control both the speed and accuracy of a given query. Queries can be performed on a pre-determined sampling percentage, which can be manipulated on a per query basis. Sampling percentages dictate the number of table partitions that are queried, and allow for a subset of table partitions to be queried, decreasing the amount of time it takes to calculate a result.

Speculation queries can be processed by the system between the receipt of real-time queries. Results from speculation queries may be cached and accessed when a relevant real-time query is received by the system, serving to reduce query response time.

Certain systems and methods provide for a master application in control of numerous distributed slave applications. The number of slave applications utilized for a query may be dictated by the sample rate set by a user. Results obtained by slave applications are aggregated by the master application and returned to the user. Slave applications also run speculation queries at the direction of the master application. If requested by the master, slave applications may also provide query accuracy information that is eventually passed along to the user. Accuracy information allows a user to appreciate the implications of the sample rate that they have selected.

### BRIEF DESCRIPTION OF THE DRAWINGS

In the following descriptions of the drawings and exemplary embodiments, like reference numerals across the several views refer to identical or equivalent features, and:

FIG. 1 schematically represents a high level view of architecture for an exemplary system embodiment;

FIG. 2 illustrates the flow of information in an exemplary system embodiment;

FIGS. 3A-3B depict an exemplary screen of an exemplary system embodiment;

FIGS. 4A-4B depict an exemplary screen of the system embodiment of FIG. 3;

FIGS. 5A-5B depict an exemplary screen of the system embodiment of FIG. 3;

FIGS. 6A-6B depict an exemplary screen of the system embodiment of FIG. 3;

FIGS. 7A-7B depict an exemplary screen of the system embodiment of FIG. 3;

FIGS. 8A-8B depict an exemplary screen of the system embodiment of FIG. 3;

FIGS. 9A-9B depict an exemplary screen of the system embodiment of FIG. 3.

### DETAILED DESCRIPTION OF THE EXEMPLARY EMBODIMENTS

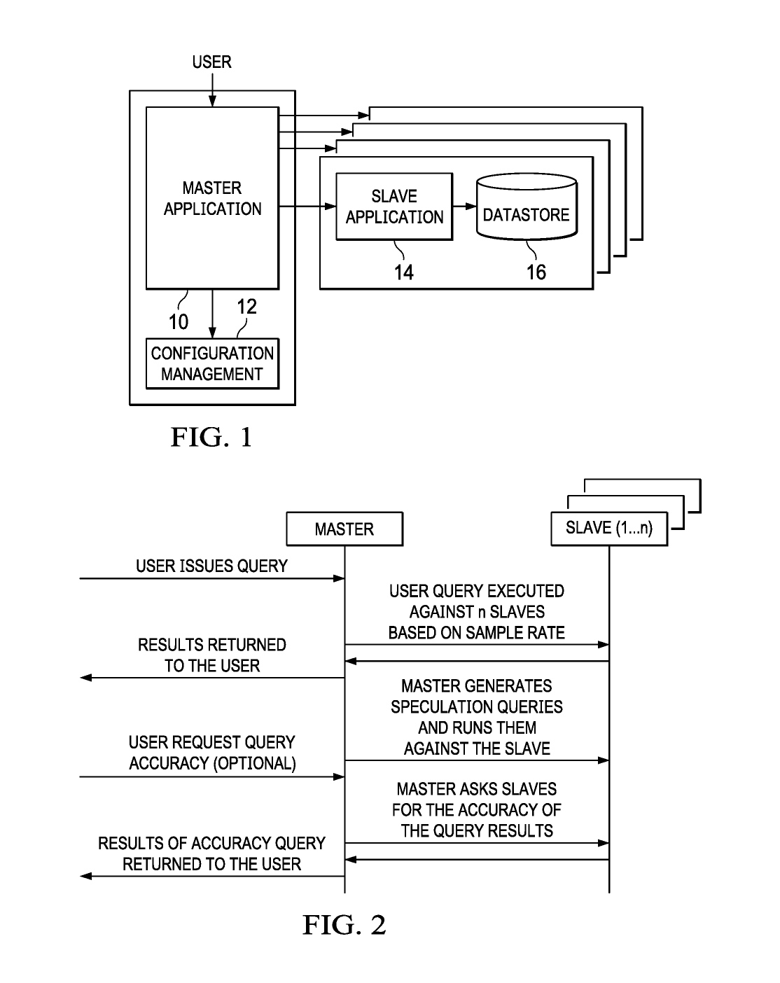

FIG. 1 illustrates an exemplary system embodiment. The system is comprised of a master application 10 in communication with a configuration management tool 12. The master application 10 communicates across a network with multiple slave applications 14. Each slave application 14 is associated with a datastore 16.

The communication between the master application and slave applications is illustrated in FIG. 2. Upon receiving a query from a user, the master application 10 executes the query through n slave applications 14, where n is based upon the data sample rate selected by the user. A comparatively higher n is used for a higher sample rate. The slave applications 14 manage execution and caching, providing their results to the master application 10. The master application 10 aggregates the results and calculates the error bounds, and communicates the overall result to the user. The configuration management tool 12 provides centralized storage of all table and cluster metadata.

The master application 10 also manages query speculation, by generating speculation queries and running them against the slave applications 14. The results of the speculation queries are executed and cached by the slave applications 14. Speculation queries may be executed until a real-time user query is received by the master application 10. Any speculation queries in process at a slave application 14 are halted upon receipt of the next user query. If a user query matches a speculation query, the result is obtained from the cached results. This process allows for reduced processing times.

Speculation may be achieved through the use of an algorithm. The algorithm anticipates what will be done next using histograms of the data that are generated when data is inserted and the cube schema that the user has provided as part of the query session. The algorithm used may be that developed by The Ohio State University (referred to as the “DICE” algorithm), shown below, or it may be another algorithm.

DICE Execution Strategy:

DICE-PLAN-DETERMINE(Q_{Spec}, CF)

| | |
|---|---|
| 1 | P_{Spec} ← GET-SPEC-PROBABILITIES(Q_{Spec}) |
| 2 | PS_{Spec} ← SIBLING-ADJUSTMENT(P_{Spec}, CF) |
| 3 | Accuracy_Gains ← GENERATE-ACCURACY-GAINS-VECTOR( ) |
| 4 | Unified_Queries ← QUERY-UNIFICATION(Q_{Spec}) |
| 5 | P_{Unified}_{_{—}}_{Queries} ← { } |
| 6 | for each UQ in Unified_Queries |
| 7 | do |

| | |
|---|---|
| 8 | P_{UQ} ← Σ_{Q∈UQ} PS_{Spec}(Q) |
| 9 | Unified_Accuracies = Unified_Queries × |

| | |
|---|---|
| 10 | Accuracy_Gains |

| | |
|---|---|
| 11 | DESC-SORT(Unified_Accuracies) |
| 12 | return Unified_Accuracies |

In other embodiments different algorithms may be used. In one embodiment, the system may use the algorithm used in Cubert (https://github.com/linkedin/Cubert).

A user may request information about query accuracy. The master application will request accuracy information from the nodes, upon which the node applications will return the error bounds for aggregation queries, based on the variance (across samples) of the measure for each group. The variance for the same group is combined across multiple queries, after which the variances across multiple groups are combined to give an error estimate for the entire query. The results are presented to the master application, which returns them to the user.

In exemplary embodiments, data injection occurs through an application program interface (API) that allows the user to perform table creation and indexing. A user also has the ability to specify the number of table columns and partitions. Partitioning may be performed through the use of a pluggable data partitioner that is Consistent Hash Ring based. Table creation may also allow a user to set the number of nodes that define a write action as a success, and how many times the data must be replicated in order to be able to stay fault tolerate. For example, in an exemplary embodiment the default on number of node to define a success may be 2, and the number of times data must be replicated to stay fault tolerant may be 3. For tables that are intended to be temporary, the interest in having a fast write speed may best be served by setting the write success to 1 and the replication factor to 1. Other tables which need higher fault tolerance may be set to higher numbers, but write speed may slow since multiple copies will be written.

The API may also allow a user to drop tables and indexes. Updates and deletions of data may also be performed by the user.

After a desired table is created, a user may also be able to inject data via individual inserts or bulk load by providing a singular csv (comma separated values) file or a directory of csv files to be imported. Upon insertion of data, a VectorClock and a unique identifier (“DID”) may be assigned to every row of data for later use. The DID is a 15 byte data structure that holds (1) time, (2) partition hash the data lives on, and (3) incremented number. In an example, a DID is written as the hex string representation 56abf2de6436343539616232134404. The partition hash of this DID is d6459ab2, the timestamp is 1454109406, and the counter is 1262596. The byte layout of an exemplary DID is shown in the table below:

| | | | | | | | | | | | | | | |
|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 |

| | | |
|---|---|---|
| time | partition hash | inc |

In different embodiments a variety of ObjectIDs of different byte sizes and configurations may be used. One example is the MongoDB ObjectID which is readily available on the internet.

During data injection, the system may gather statistics about the data and store the statistics. Unlike other systems, including RDBMS, in a system of an exemplary embodiment histogram data is collected in real time to allow the system to know what the bounds of the data is. The statistic information may later be used by the system to assist with speculation queries.

In exemplary embodiments the system performs data repair functions. In order to fix data failures and/or inconsistencies, the system uses Vector Clocks in order to create a sense of “time.” When a singular get request is made by a unique identifier (DID) for each row, it checks to see whether or not repair is necessary. All data is pulled from all active nodes and the vector clocks are compared. The comparison allows for a determination of the latest version of the data and necessary updating.

In exemplary embodiments, data is not permanently deleted at first, but rather is “soft” deleted by adding a timestamp to the row when it occurs. Each slave executes a process that runs to see if there are any records in the database that need to be permanently deleted. Timestamps associated with the “soft” deletions are reviewed, and if any soft deletions are found to be older than a predetermined time (for example, 7 days) then the associated records will be permanently deleted.

In an exemplary embodiment, an API allows a user to search via an SQL query submitted to the system. The user can also use the API to define the data sample rate that they would like to use, which may be any amount up to and including 100%. The sample rate selected by a user dictates the number of table partitions that the system will search for a particular query. It may be desired by a user to only query 20% of the available data in order to obtain a quicker response than a query of all the data will provide. However, if a user believes that a low rate will present an anomaly, or if a user otherwise desires a larger set of data to search, the user may select a higher percentage (such as 90% or 100%) of the data to query. Selection of a higher rate may cause a longer delay in result time. It will be appreciated by those of ordinary skill in the art that users may have various reasons for selecting different data sampling rates.

The user also has the ability to define the dimensions of the cube that the user's query session will utilize.

In an example, a table has a six-column structure with the following structure:

| | | | | | |
|---|---|---|---|---|---|
| userid | year | month | day | type | domain |

Each of the columns is a dimension. A query based on time and domain would look like year, month, day; type. A comma dictates a hierarchical dimension, giving the system more information on how it should do speculation queries, whereas a semicolon separates the different dimensions. As a user queries using one of the dimensions in a hierarchy speculation engine will only query up or down the hierarchy causing less speculation queries to be generated but more correct queries to allow for less work and more benefit for the user's query speed. If defined as a non-hierarchical cube dimension like: year; month; day; type there would be 2× as many queries executed because the speculation engine would use all dimensions defined to build out the cube instead of the better defined hierarchy of dimensions.

Through the API the user may also be able to request the accuracy/error rate of a given query and sampling rate. In exemplary embodiments the system is not only able to determine the accuracy/error rate for a single aggregate, but may also perform accuracy calculations across multiple aggregates as would be seen in more complex queries.

In an exemplary embodiment, the system can support various types of data types, including SMALLINT, INTEGER, BIGINT, DECIMAL, REAL, DOUBLE, BOOLEAN, CHAR, VARCHAR, DATE, TIMESTAMP, and ARRAY. In other embodiments different data types may be supported. In some embodiments of the system, unsupported data formats can be converted into accepted formats.

In an exemplary embodiment the system is Linux based, and readily-available software tools used to build and operate the system include the following: LOGBACK (http://logback.gos.ch/, ch.qos.logback:logback-classic:1.1.7, ch.qos.logback:logback-core:1.1.7); JACKSON (https://github.com/FasterXML/jackson, com.fasterxml.jackson.core:Jackson-annotations:2.7.0, com.fasterxml.jackson.core:Jackson-core:2.7.4, com.fasterxml.jackson.core:Jackson-databind:2.7.4, com.fasterxml.jackson.datatype:Jackson-datatype-guava:2.7.4); GUAVA (https://github.com/google/guava, com.google.guava:guava:19.0); FLIPTABLES (https://github.com/JakeWharton/flip-tables, com.jakewharton.fliptables:fliptables:1.0.2); AKKA (http://akka.io/, com.typesafe.akka:akka-actor_2.11:2.4.4, com.typesafe.akka:akka-cluster-metrics_2.11:2.4.4, com.typesafe.akka:akka-cluster-tools_2.11:2.4.4, com.typesafe.akka:akka-cluster_2.11:2.4.4, com.typesafe.akka:akka-kernel_2.11:2.4.4, com.typesafe.akka:akka-protobuf_2.11:2.4.4, com.typesafe.akka:akka-romote_2.11:2.4.4, com.typesafe.akka:akka-slf4j_2.11:2.4.4); TYPESAFE CONFIG (https://github.com/typesafehub/config, com.typesafe:config: 1.3.0); HIKARI CONNECTION POOL (https://github.com/brettwooldridge/HikariCP, com.zaxxer:HikariCP:2.4.6); APACHE COMMONS (https://commons.apache.org, commons-cli:commons-cli:1.3.1, commons-io:commons-io:2.5, org.apache.commons:commons-collections4:4.1, org.apache.commons:commons-lang3:3.4, org.apache.commons:commons-math3:3.6.1); NETTY (http://netty.io/, io.netty:netty:3.10.3.Final); JODA TIME (http://www.joda.org/joda-time/, Joda-time:joda-time:2.9.3); ANTLR (http://www.antlr.org/, org.antlr:antlr4-runtime:4.5.3, org.antlr:antlr4:4.5.3); JOOQ (http://www.jooq.org/, org.jooq:jooq:3.8.0); MSGPACK (http://msgpack.org/index.html, org.msgpack:Jackson-dataformat-msgpack:0.8.7, org.msgpack:msgpack-core:0.8.7); POSTG RES JDBC DRIVER (https://jdbc.postgresql.org/, org.postgresql:postgresql:9.4-1206-jdbc42); SCALA (http://www.scala-lang.org, org.scala-lang.modules:scala-java8-compat_2.11:0.7.0, org.scala-lang:scala-library:2.11.7); SLF4J (http://www.slf4j.org, org.slf4j:log 4j-over-slf4j:1.7.21, org.slf4j:slf4j-api:1.7.21); UNCOMMONS MATH (http://maths.uncommons.org., org.uncommons.maths:uncommons-maths:1.2.2a); JEDIS (https://github.com/xetorthio/jedis, redis.clients:jedis:2.8.1).

It will be appreciated by one of ordinary skill in the art that many other software tools, and combinations of tools, may be used to create the embodiments described herein, and that the preceding list is in no way limiting.

### Example 1

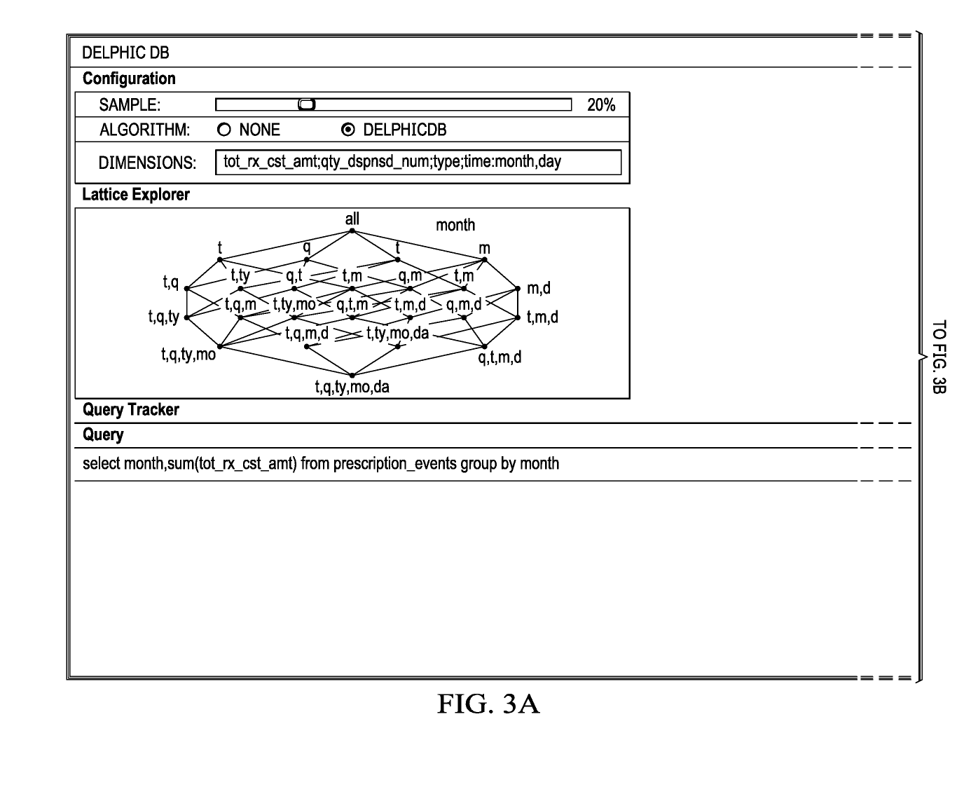

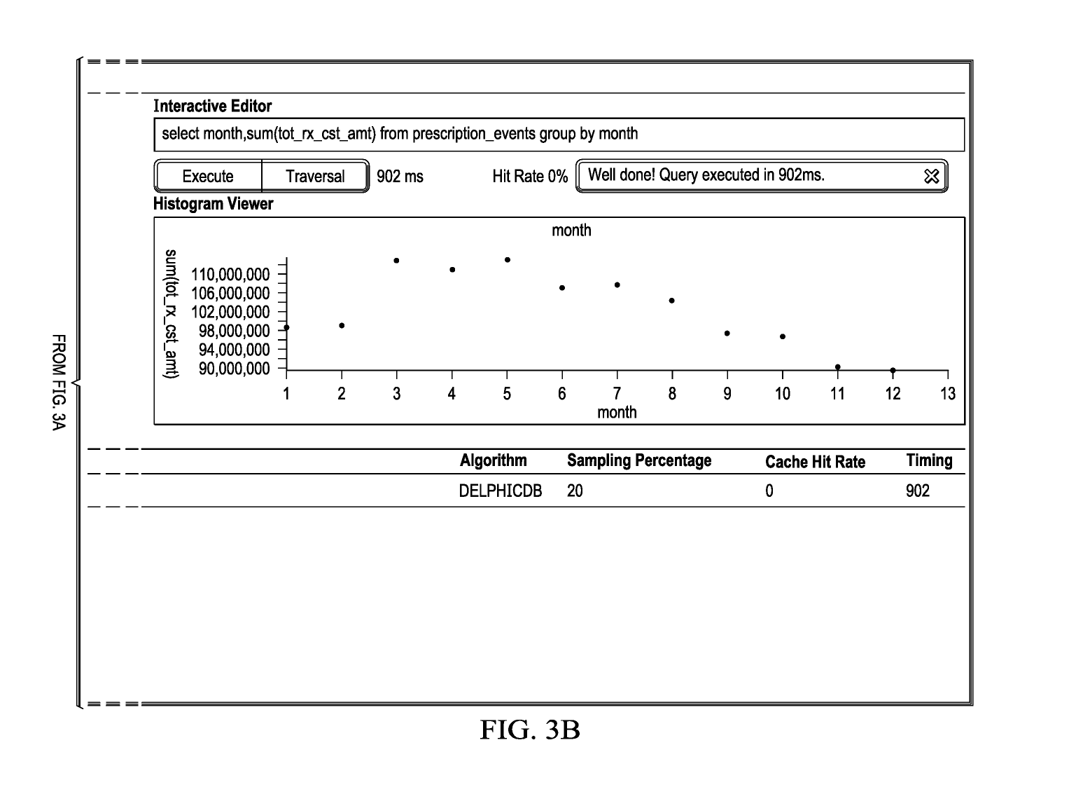

In an exemplary system embodiment as illustrated in FIGS. 1 and 2, prescription drug data from the Center of Medicare and Medicaid Services totaling 110 million records is matched up with the FDC National Drug Code directory in order to identify the type and name of prescription drugs. FIG. 3 is a display of the exemplary system embodiment. The display shows an initial query run by a user on the prescription data, where the query seeks a high level review of what the total cost spend is, broken down by month. The system samples the records at 20%, which is identified as the “Sampling Percentage” on the display of FIG. 1. As shown in FIG. 3, the sampling of the records at 20% is able to return a result in 902 milliseconds (ms).

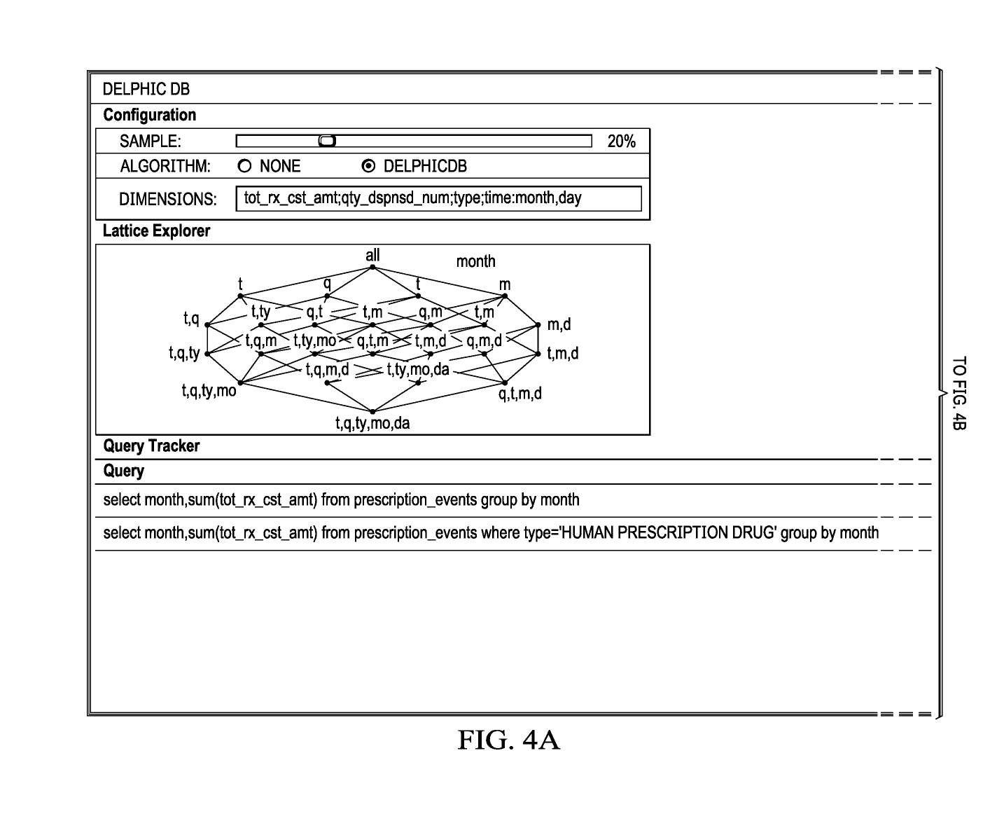

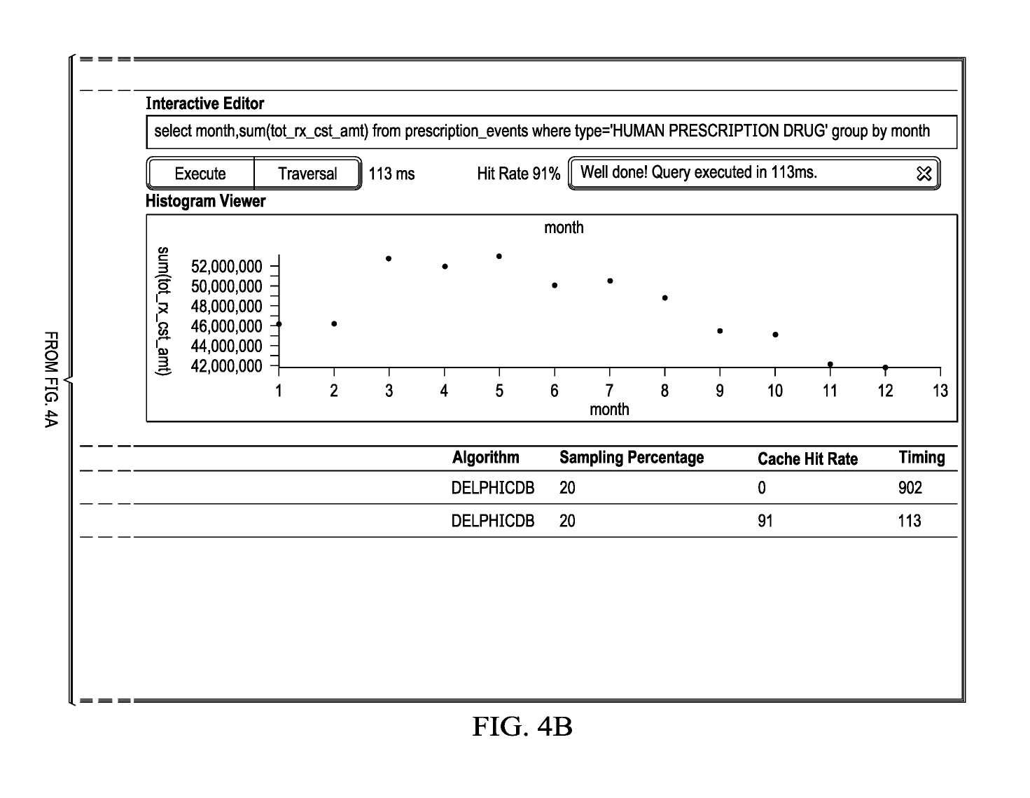

Once an initial query is run on the data, subsequent queries may be run on the results of the prior query. FIG. 4 is a display showing a second query run on an embodiment of the system subsequent to the query of FIG. 3. The second query is for HUMAN PRESCRIPTION DRUGS, still broken down by total cost spend by month. The system is able to utilize the real time cube created during the first query for processing the vast majority of the second query. As shown in the display on FIG. 4, the cache hit rate was 91%, meaning that the rest of the data, approximately 9%, was retrieved from the underlying datastore. By being able to utilize the cache, the system is able to answer the query in 113 ms, much faster than the initial query.

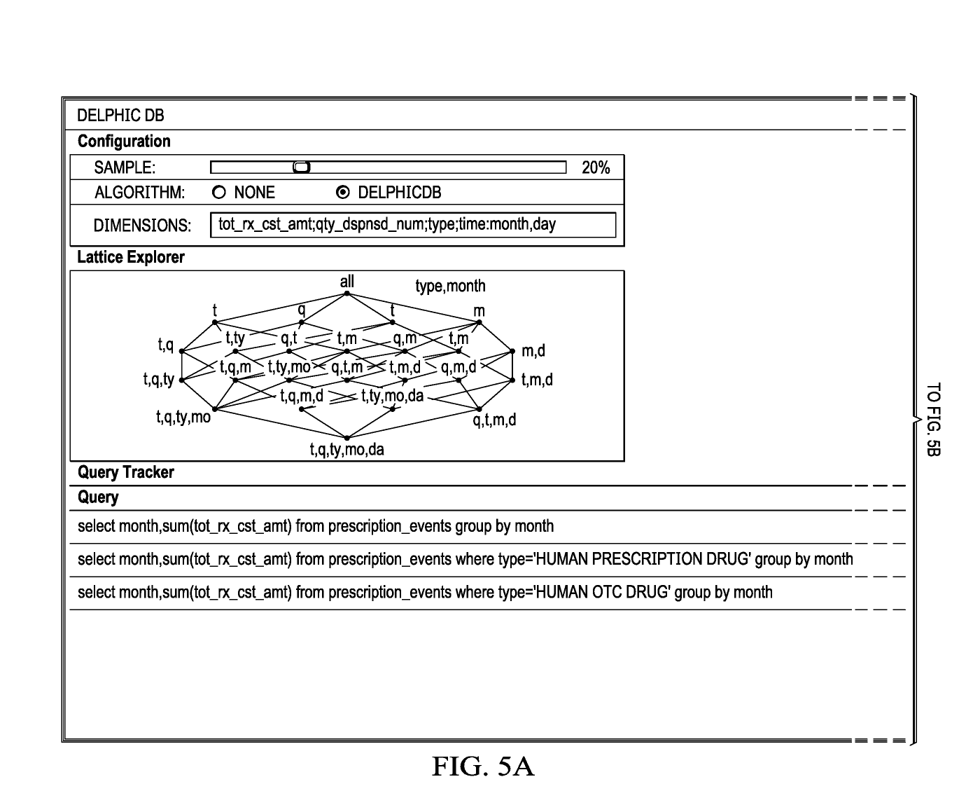

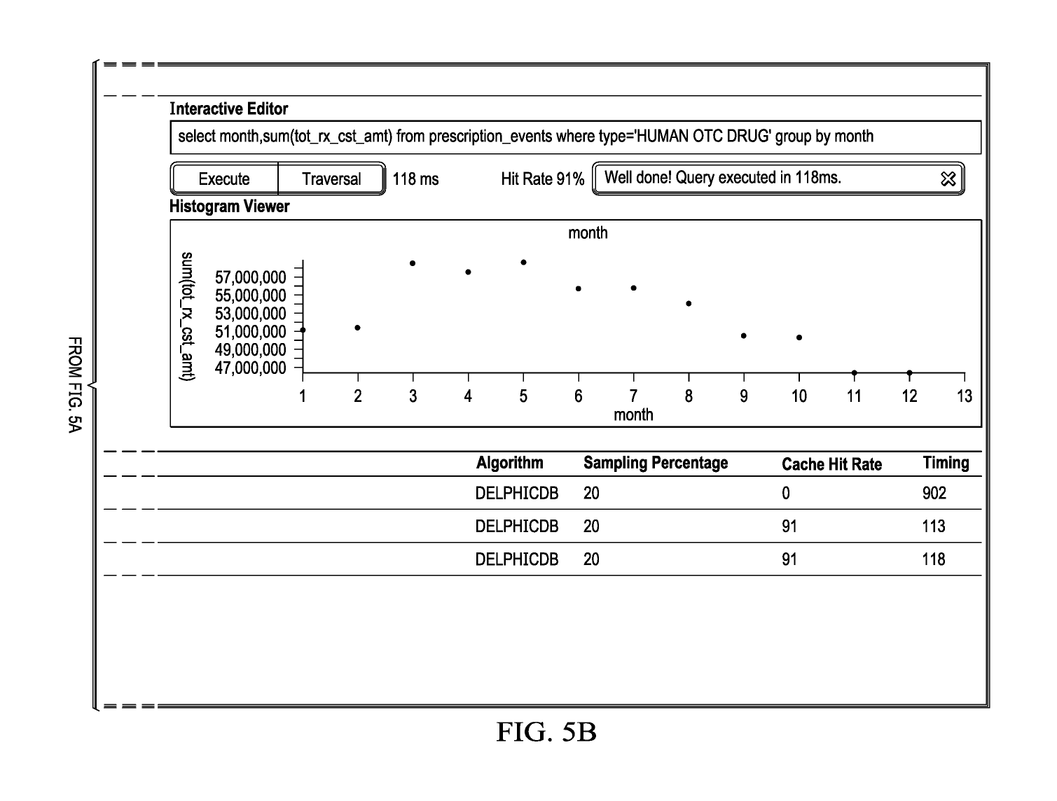

FIG. 5 is a display showing a third query run on the embodiment of the system subsequent to the query of FIG. 4. The third query is for “HUMAN OTC DRUG”, still broken down by total cost spend by month. The system is again able to utilize 91% real time cube (cache hit rate) created during the first query, allowing the system to return results in 118 ms.

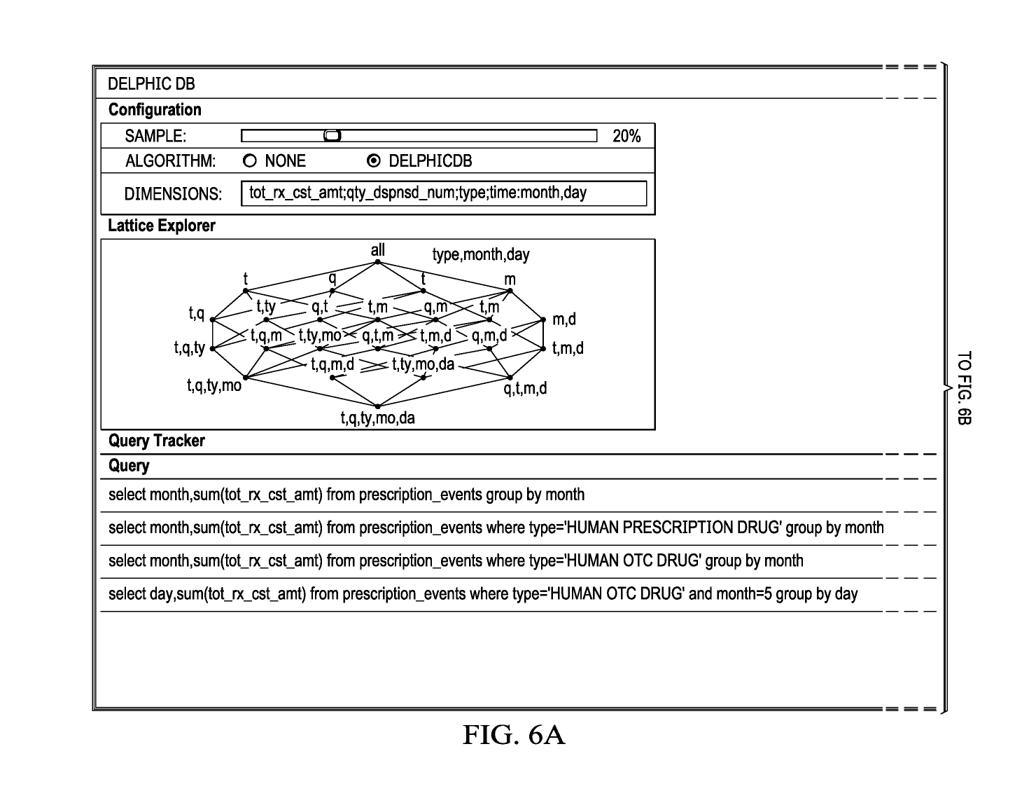

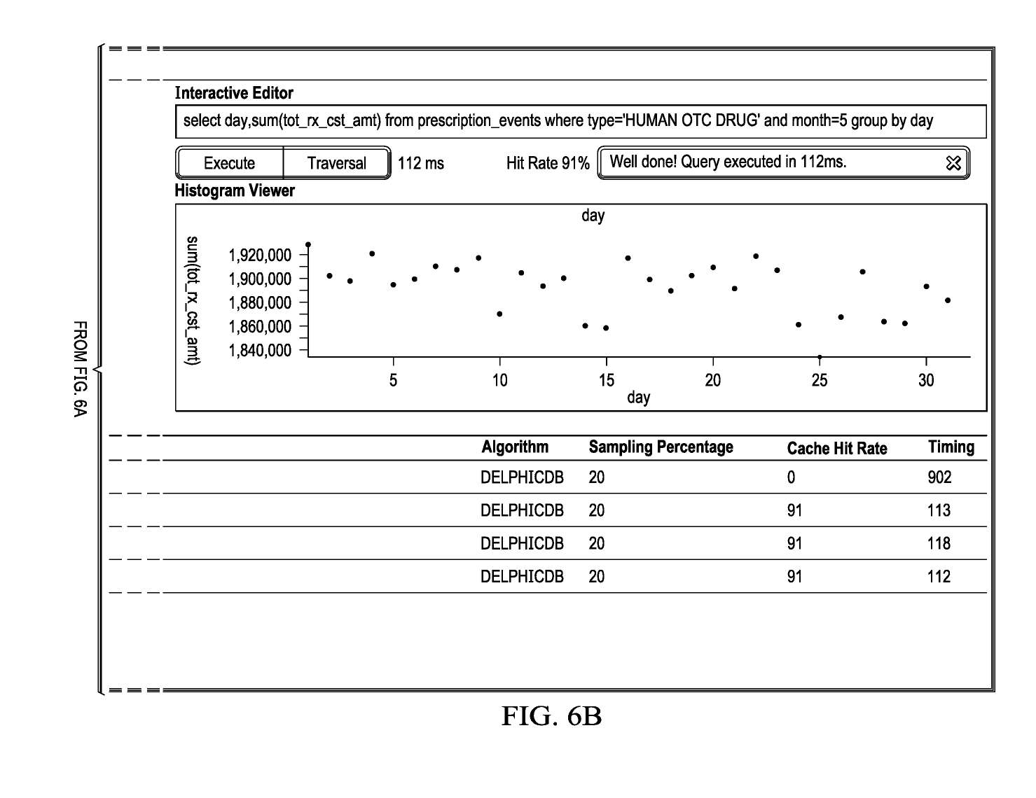

FIG. 6 is a display showing results of a fourth query run on the embodiment of the system subsequent to the query of FIG. 5. The fourth query is to analyze the results broken down by the day of the month. The system is again able to utilize 91% of the real time cube created during the first query, allowing the system to return results in 112 ms. Day by day data may show any patterns in cost spent throughout the month for a given drug time (in this case HUMAN OTC DRUG). Any disproportionately high or low spots on the data could be visually identified, and may be caused by numerous factors, including points during the month when customers have more or less money available to make drug purchases with.

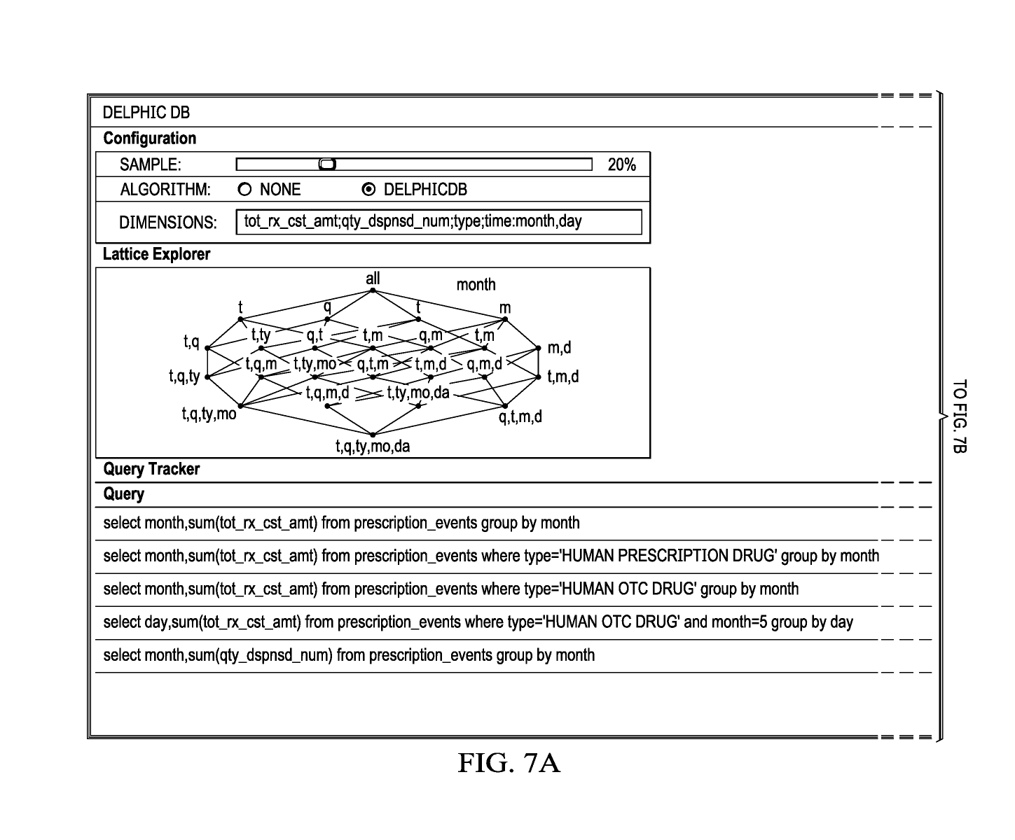

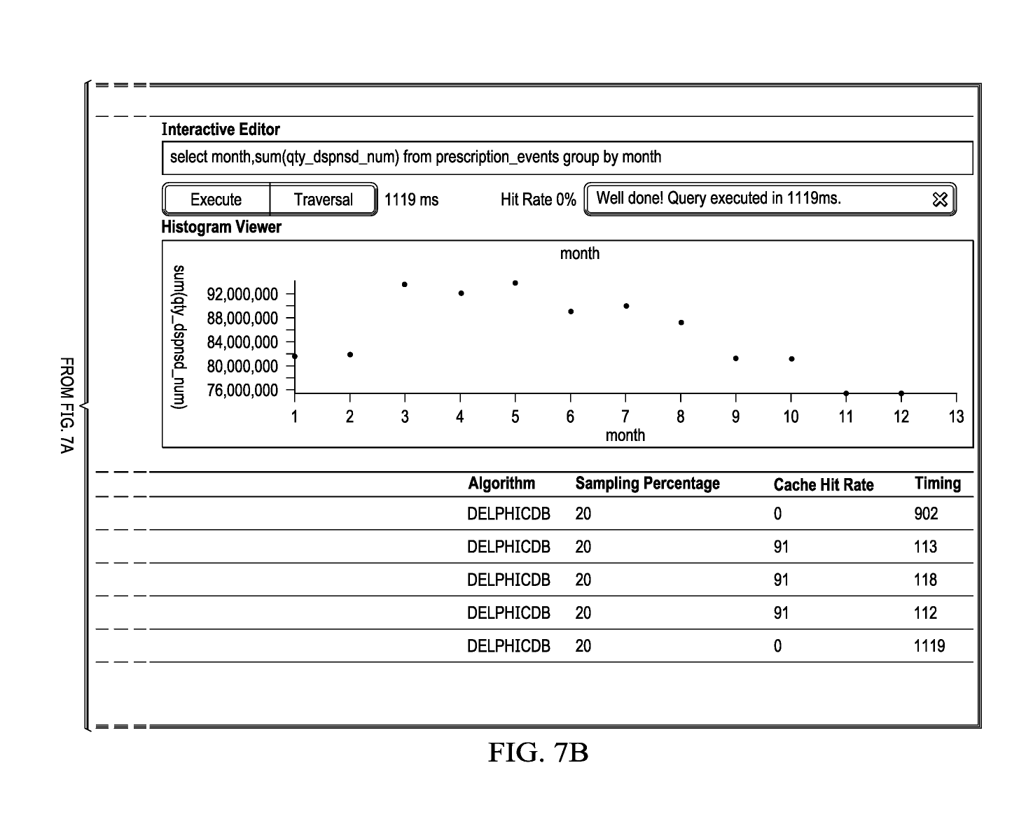

FIG. 7 is a display showing results of a fifth query run on an embodiment of the system subsequent to FIG. 6. The fifth query is for a breakdown of quantity of prescriptions dispensed according to months of the year. The results were obtained in 1119 ms, slower than the results of earlier queries. The comparatively slow result time is due to the fact that dimensions of the query changed. Due to the change in dimensions, the real time cube was used at 0%.

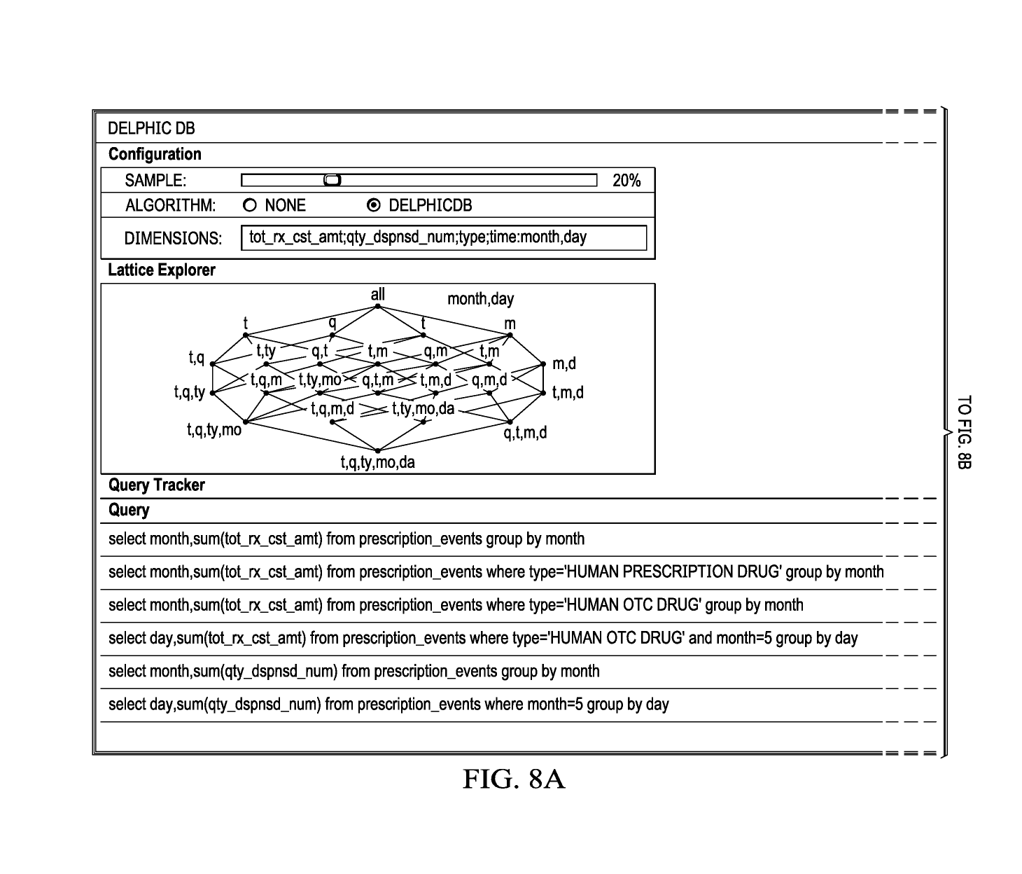

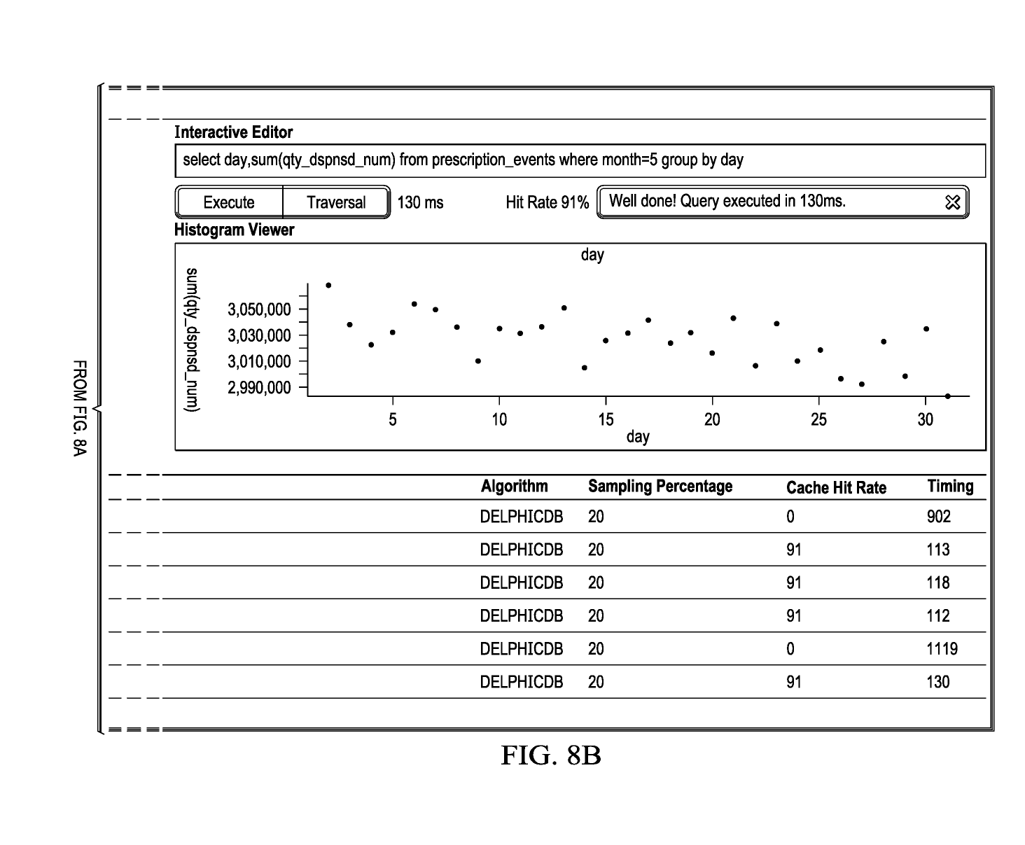

FIG. 8 is a display showing the results of a sixth query run on an embodiment of the system subsequent to the query of FIG. 7. The sixth query is for a break down by day of the month of May. The system is able to utilize the real-time cube at a 91% rate and provide a response in 130 ms. Even though the user changed the dimension during the fifth query, during the sixth query the system was able to compensate and allow for a faster query response time. The system is able to compensate and provide the performance gain because the aggregated dimension (sum(qty_dspnsd_num)) utilized between the 5^{th} and 6^{th} queries are the same.

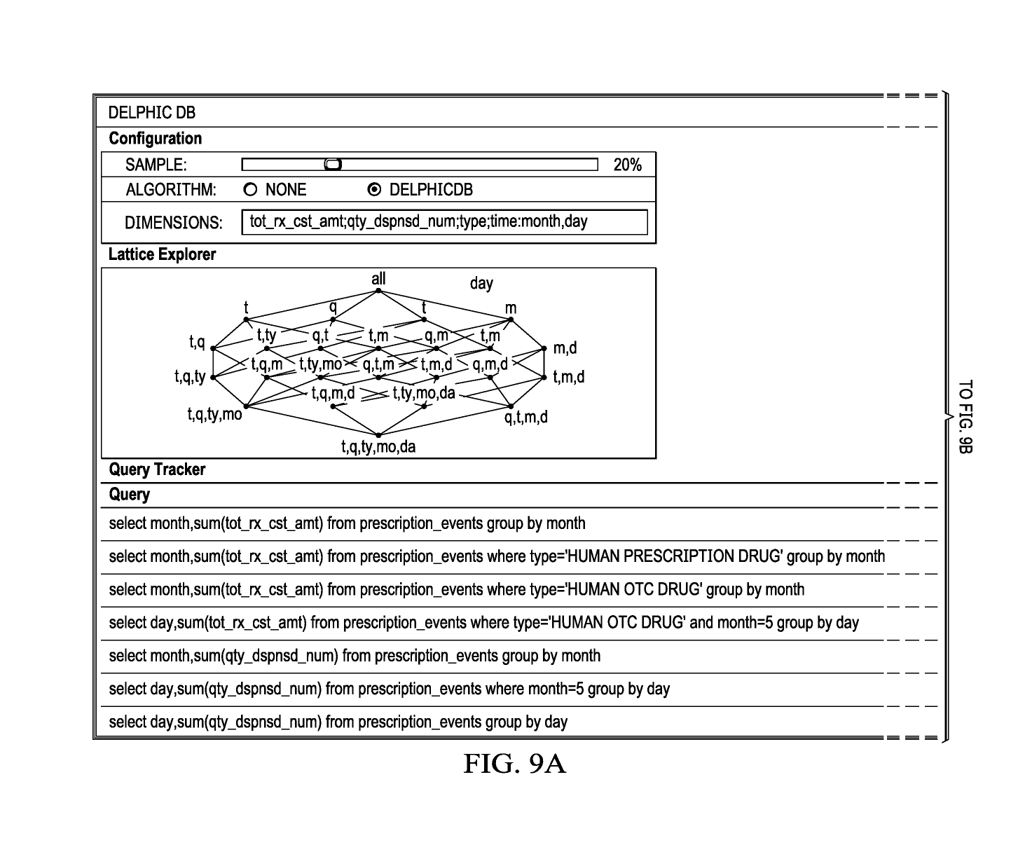

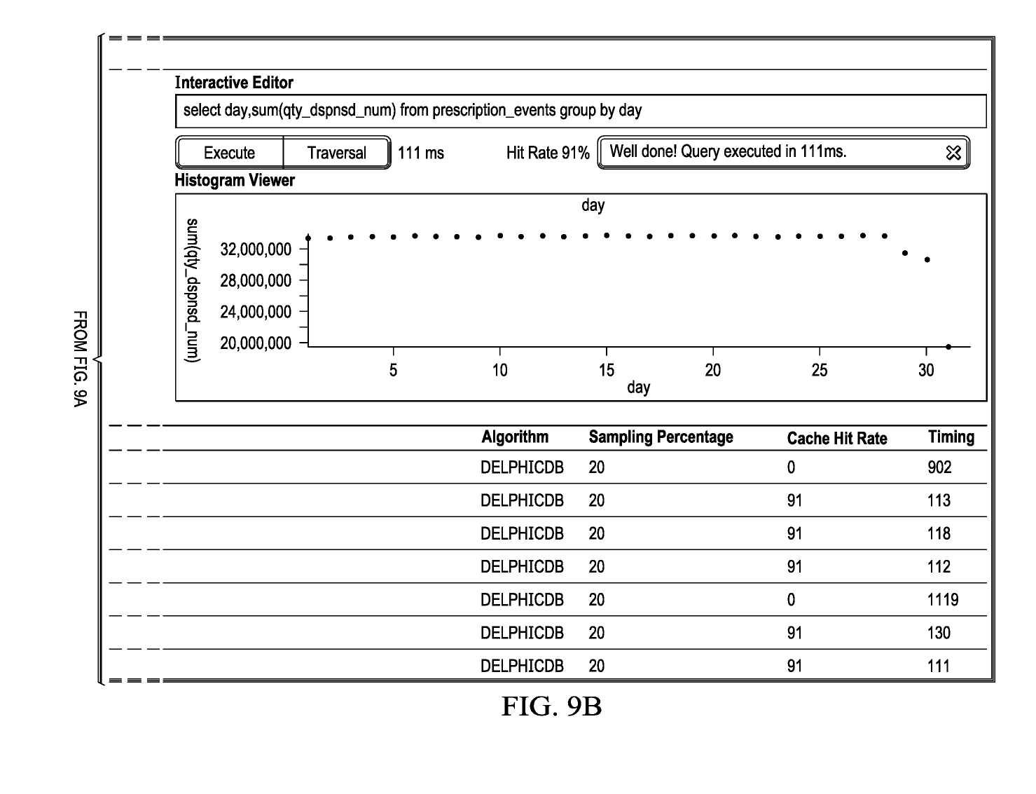

FIG. 9 is a display showing the results of a seventh query run on an embodiment of the system subsequent to the query of FIG. 8. The seventh query is for an analysis of trend in quantity dispensed broken down by day only. The seventh query is a broader query than the sixth query. The system is able to utilize the real time cube at a 91% rate, providing a response in 111 ms.

### Example 2

A comparison of query processing times on publicly available data from Center of Medicare and Medicaid Services was made against Amazon Redshift. The raw data set size was a total of 92,500,000 records.

Amazon Web Services EC2 instances were used. Five slave nodes were created using a m3.2xlarge size, as well as one master node using a m3.xlarge size. Each of the slaves utilized Postgres 9.3 as the underlying datastore. The data size was the same as the raw data set size, 92,500,000 records, and the records were split across 185 partitions. The partitions were split across the five slave nodes, causing each slave node to handle 37 partitions a piece.

An Amazon Web Services Redshift cluster of 2 nodes using the dc1.8xlarge instance was used. Since Redshift does not support the Postgres Array structure, the data set was formed into 197,451,376 records since each entry in the Array had to be its own row in a table instead of a single row with an array of values.

A series of queries were executed against both systems. Those queries and the time taken for the results are shown in the table below:

TABLE 1
COMPARISON OF EXEMPLARY EMBODIMENT WITH REDSHIFT

| | REDSHIFT | DELHPICDB |
|---|---|---|
| QUERY | (ms) | (ms) |
| select icd9dgnscode,COUNT(deceased),SUM(total_linecoinsrncamt) from | 780.25 | 126.33 |
| beneficiary_carrier_1_claims_mat where deceased=‘true’ and age<‘50’ group by icd9dgnscod | | |
| select age,COUNT(deceased),SUM(total_linecoinsrncamt) from beneficiary_carrier_1_claims_mat | 398.75 | 182.33 |
| where deceased=‘true’ | | |
| and ‘75319’=ANY(icd9dgnscode) group by age | | |
| select age,COUNT(deceased),SUM(total_linecoinsrncamt) from beneficiary_carrier_1_claims_mat | 357.75 | 126 |
| where deceased=‘true’ | | |
| and ‘7533’=ANY(icd9dgnscode) group by age | | |
| select age,COUNT(deceased),SUM(total_linecoinsrncamt) from beneficiary_carrier_1_claims_mat | 346.5 | 75.67 |
| where deceased=‘true’ group by age | | |
| select age,COUNT(deceased),SUM(total_linecoinsrncamt) from beneficiary_carrier_1_claims_mat | 405 | 123.67 |
| where deceased=‘true’ | | |
| and ‘5851’=ANY(icd9dgnscode) group by age | | |
| select age,COUNT(deceased),SUM(total_linecoinsrncamt) from beneficiary_carrier_1_claims_mat | 416 | 239 |
| where deceased=‘true’ | | |
| and ‘5852’=ANY(icd9dgnscode) group by age | | |
| select age,COUNT(deceased),SUM(total_linecoinsrncamt) from beneficiary_carrier_1_claims_mat | 421.5 | 150.33 |
| where deceased=‘true’ | | |
| and ‘5853’=ANY(icd9dgnscode) group by age | | |
| select age,COUNT(deceased),SUM(total_linecoinsrncamt) from beneficiary_carrier_1_claims_mat | 414.75 | 192 |
| where deceased=‘true’ | | |
| and ‘5854’=ANY(icd9dgnscode) group by age | | |
| select icd9dgnscode,COUNT(deceased),SUM(total_linecoinsrncamt) from | 521.25 | 61 |
| beneficiary_carrier_1_claims_mat | | |
| where deceased=‘true’ and age<‘50’ and benesexidentcd=1 group by icd9dgnscode | | |
| AVERAGE TIME TAKEN: | 451.25 | 141.67 |

While certain exemplary system and method embodiments are described in detail above, the scope of the invention is not considered limited by such disclosure, and modifications are possible without departing from the spirit of the invention as evidenced by the claims.

What is claimed is:

1. A system for importing data, comprising:
a master application in communication with a configuration management tool; and
at least one slave application;
wherein the master application executes a query through the at least one slave application.
